(19) United States
(12) Patent Application Publication
(10) Pub. No.: US 2008/0294407 A1
(43) Pub. Date: Nov. 27, 2008

(54) Method and Apparatus for Computational Modeling of Malignant Transformation in Tissue

(76) Inventors: Hava Siegelmann, Brookline, MA (US); Nava Siegelmann-Danieli, Tel-Aviv (IL)

Correspondence Address: LAW OFFICE OF BRUCE D. RUBENSTEIN, 405 WALTHAM STREET, # 404, LEXINGTON, MA, 02421-7934, US

(21) Appl. No.: 12/125,518

(22) Filed: May 22, 2008

Related U.S. Application Data
(60) Provisional application No. 60/931,483, filed on May 23, 2007.

(51) Int. Cl. G06G 7/48

(52) U.S. Cl. 703/11

(57) ABSTRACT

A computational system and method for simulating biological tissue includes a computer-modeled 3-dimensional space in which computer-modeled cells are located. The cells may be either healthy or cancerous. As a simulation progresses, the cells may execute a variety of protocols. These include life protocols, such as replication, repair, and apoptosis. They also include signaling protocols, such as a request from a cell to entice defective neighboring cells to die, and an announcement that a cell itself is about to die. The announcement, when received by neighboring cells, tends to entice them also to die. Since defective cells tend to cluster together, the combination of the two signals within a tumor has a strong effect on suppressing the tumor. The simulation tracks the progression of cancerous tumors as well as the effectiveness of various treatments. By simulating the behavior of cancerous tissues, the system and method disclosed herein provide a model for understanding cancer, from which potential treatments may be conceived.

### CROSS-REFERENCES TO RELATED APPLICATIONS

This application claims priority to U.S. provisional patent application No. 60/931,483, filed May 23, 2007, and having the same title as provided above.

### STATEMENT REGARDING FEDERALLY SPONSORED RESEARCH OR DEVELOPMENT

Not Applicable.

### NAMES OF PARTIES TO A JOINT RESEARCH AGREEMENT

Not Applicable

### REFERENCE TO A “SEQUENCE LISTING,” A TABLE, OR A COMPUTER PROGRAM LISTING APPENDIX

Not Applicable.

### BACKGROUND OF THE INVENTION

1. Field of the Invention

This invention pertains generally to systems and methods for computer modeling of natural phenomena and, more particularly, to the modeling of biological organisms including normal and aberrant cell growth.

2. Description of Related Art

Current traditional methods to eradicate and/or suppress tumors include surgery, chemotherapy, hormonal therapy, immunotherapy, and radiotherapy. More recently, biological agents targeting abnormal processes in malignant cells or their environment are incorporated as well. Examples include blockage of the over-expressed cKit thyrosine kinase by Gleevec in gastrointestinal stromal tumors, and naturalizing the vascular endothelial growth factor responsible for tumor angiogenesis by the humanized antibody bevacizumab, respectively.

A final common pathway for all current anti-cancer agents involves signaling towards activation of the programmed cell death (apoptotic) process. Ideally, the apoptotic signaling should specifically affect all cancer cells and spare the normal surrounding ones. What is desired is a computer simulation model of cell behavior that provides for optimization of this process.

### BRIEF SUMMARY OF THE INVENTION

The present invention provides a computational system and method for mimicking tissue composed of cells. The present invention can simulate both the growth of a biological tissue that starts with a stem cell and the growth of a tumor. The present invention preferably provides a visualization of the entire tissue being modeled, but also can be run by command line if only numerical results are desired. Each cell in the simulation includes regulation factors that control whether the cell will replicate, die, repair itself, or suppress tumor formation. During the simulation these factors may cease functioning, simulating mutations in a cell's genes. One way a tumor can be formed in the system is via these mutations over a long period of time. The other way is if the user plants one tumor cell into the tissue. For either situation the development of the tumor from the single cell is then simulated.

The system and method of the present invention also models inter-cellular signaling to convince cells to kill themselves even after they've lost their self-check mechanisms. A large variety of user chosen parameters enable the simulation of different signaling mechanisms (such as how far they travel, how long they stay, etc.) and of different signal types. These signal types and their combination simulate different methods of tumor suppression. Users can also decide how sensitive a cell will be to the signals that it receives.

The system and method of the present invention can be used to examine certain aspects of tumor formation as well as testing different directions towards suppressing or eliminating tumor growth. The simulation system and method of the present invention contains far fewer details than the biological system being represented, allowing for the design and analysis of signaling protocols, using algorithmic techniques, to both prevent and fight damaged cells.

In a simulation system and method in accordance with the present invention each cell is ruled by basic life protocols. Major violations to those rules lead to the development of aberrant mutated cells. Those aberrant cells that lack the ability to sense their damage before multiplying continue replication and exhaust the simulated biological system's resources.

A computational modeling system and method in accordance with the present invention provides for the introduction of simulated rescue protocols based on inter-cell communication that signals cells to go apoptosis. With this view, the cells are active citizens working in harmony towards the modeled biological system's health and recovery by being alert and passing along messages. Success can be evaluated by the pace of the modeled biological system's recovery and by the end ratio of normal to aberrant cells at an equilibrium point. It has been found that, at that point, mutated cells, if still existing, are highly restricted and not able to move or replicate further, and healthy cells regenerate to reassume the modeled biological system's functionality. Furthermore, the healthy cells now have a higher level of alertness, being now more ready to attack any new aberrant cells that may occur. In accordance with the present invention, the rescue algorithms may be tested both stand-alone and when combined with different existing treatments that may be simulated as well, e.g., surgery, radiotherapy and chemotherapy.

Using a computational modeling system and method in accordance with the present invention, it was determined that the optimal rescue protocol required the initiation of apoptotic signals by both normal alert cells and during apoptosis of dying cells, both healthy and aberrant ones. Using the computational modeling system, timing, level of alertness, strength of signals and threshold for apoptosis induction may be tuned to reach optimal behavior. Different parameters may be adaptively chosen based on the modeled system's characteristics, such as late versus early initiation of the rescue protocol, level of aggressiveness of the aberrant cells, and proliferation rates of the local healthy cells.

Thus, a computational model and associated system in accordance with the present invention provide a powerful tool to exercise biological processes and solutions and in particular to identify rescue protocols and citizenship properties of the cells. A system and method in accordance with the present invention would, therefore, be useful as both a classroom tool and a research tool, with research focusing on finding the limitations of tumors and when they will die due to signaling. For example, drug design companies, research hospitals, and universities will be able to use a system and method in accordance with the present invention to examine possibilities for the apoptosis-inducing signaling among cells. The present invention will therefore be useful to initiate and test ideas before spending a large amount of money on testing in a biological system. Universities, high schools, and research companies will also be able to use the software to better understand the processes of tissue development and maintenance in addition to tumor development and suppression.

Further objects, features, and advantages of the present invention will be apparent from the following detailed description of the present invention, taken in combination with the accompanying drawings.

### BRIEF DESCRIPTION OF THE SEVERAL VIEWS OF THE DRAWINGS

FIG. 1 is a schematic block diagram of an exemplary computer system in which a computational modeling system and method in accordance with the present invention may be implemented.

FIG. 2 is a schematic two dimensional representation showing the exemplary relative positional spacing between normal and aberrant cells in a computational model in accordance with the present invention.

FIG. 3 is an exemplary graphical user interface for setting simulation and cellular controls for a cellular tumor simulation using a computational modeling system and method in accordance with the present invention.

FIG. 4 shows exemplary graphical visualization outputs of a computational modeling system and method in accordance with the present invention.

FIG. 5 is an exemplary graphical user interface for specifying inter-cellular tumor signaling parameters for cellular tumor simulation using a computational modeling system and method in accordance with the present invention.

FIG. 6 is an exemplary graphical user interface for introducing external therapies into a biological system being simulated using a computational modeling system and method in accordance with the present invention.

FIGS. 7-22 illustrate the results of various simulations of tumor growth with various different signal parameter combinations using a computational modeling system and method in accordance with the present invention.

### DETAILED DESCRIPTION OF THE INVENTION

To investigate the tactic of signal transduction, affecting survival of tumor cells which have developed in a previously healthy host, a system and method in accordance with the present invention employs a computational modeling system and method that contains cells residing and moving in a three dimensional grid. The cells follow the healthy cell cycle and they may mutate during proliferation. The system described routes to tumor development in terms of disruption to system regulation and accumulation of mutations associated with the malignant process. The system and method of the present invention employs rescue algorithms that have been designed based on “citizenship properties” of the cells, with the goal to eradicate the aberrant cells or confine them and restore the full functionality of the biological system being monitored. In other words, the rescue algorithms initiate induction of apoptosis in transformed cells while not reducing the regeneration abilities of the normal cells.

A system and method in accordance with the present invention enables an operator to pause the natural development at any point, store the state where it is, and continue from that point with various optional treatment algorithms in order to determine the best choice for the given dynamic configuration. The treatments may include simulations of surgery, radiotherapy, and chemotherapy (hormone and biological therapy simulations are also possibilities), to the extent wanted, or their combinations, and also various rescue protocols. The rescue protocols are parameterized by different properties such as the signals' strength and the distance they travel, the sensitivity level of the cells that initiate these signals, as well as the amount of such signals required to wake an otherwise problematic apoptosis. In such a way it is possible to design combination algorithms for best fighting of the particular tumor based on its level of aggressiveness and its size at the time of starting the treatment.

A computational modeling system and method in accordance with the present invention enables the simulation and analysis of different signaling protocols. Two protocols were found most sufficient to eradicate tumors when working together. One protocol is initiated by healthy cells that sense aberrant cells around them and initiate signals to alert cells and to initiate apoptosis. The other protocol is initiated by the death of (aberrant or normal) cells (which are dying due to this combination protocol). It was previously found that the death of (healthy) cells entices increases in the local cells proliferation. Use of a computational modeling system and method in accordance with the present invention suggests that the death of (both aberrant and normal) cells can also initiate communication and entices the death of other aberrant cells.

A computational system and method in accordance with the present invention and exemplary experimental citizenship protocols studied to restore biological system regularity using such a system and method will now be discussed in further detail.

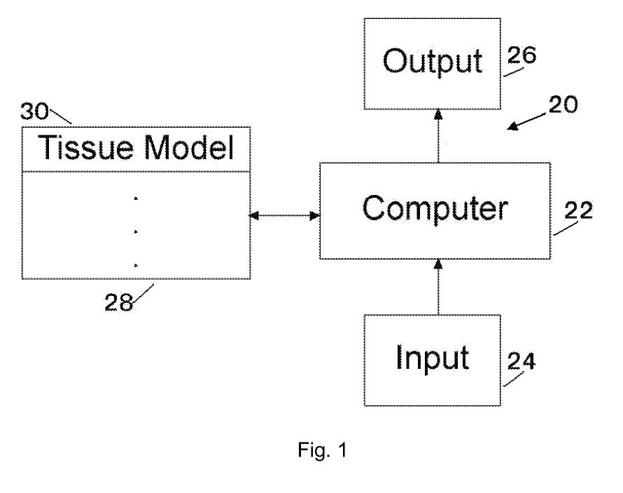

An exemplary computer based system 20 for implementing a computational modeling system and method in accordance with the present invention is illustrated in, and will be described with reference to, FIG. 1. A computational modeling system and method in accordance with the present invention may preferably be implemented in a conventional computer 22, such as a conventional PC or MAC or any other type of computer or group of computers connected together in any form, such as via a wired or wireless network. The computer 22 on which the system and method of the present invention is implemented preferably includes conventional input devices 24, such as a keyboard, mouse, etc., and output devices 26, such as a monitor, printer, etc., connected thereto. The input 24 and output 26 devices allow an operator of the system 20 to interact with the computational modeling system and method of the present invention and to view the results provided by the system and method, in a manner to be described in more detail below. System memory 28 preferably is provided as part of and/or connected to the computer 22. The system memory 28, which may include RAM, removable or hard disc memory and/or other memory devices, preferably includes tissue modeling software 30 to implement a computational model of malignant transformation in tissue in accordance with the present invention. System memory 28 preferably also contains conventional operating system and other general software applications required or desired for operation of the computer 22. Based on the detailed description and drawings provided herein, a person of ordinary skill in the art of computer programming of medical or biological simulations will be able to implement a computational modeling system and method in accordance with the present invention using conventional programming languages, such as C++, and programming techniques on conventional computer hardware running conventional operating systems, such as Windows.

A detailed description of the structure and operation of a computational model of malignant transformation in tissue in accordance with the present invention will first be provided. A computational modeling system and method in accordance with the present invention provides for the modeling and simulation of a multi-cell biological system which enables the study of cell damage, as well as the design and testing of a battery of rescue protocols, which work as stand alone or together with existing therapies.

The central modeled element of a system and method in accordance with the present invention is a cell. Each modeled cell may be stored within the system using any conventional or convenient data structure. Each modeled and stored cell is defined by several characteristics.

Each cell is defined as either a normal cell or a mutated or aberrant cell. Whether a cell is normal or aberrant defines other characteristics of the cell. The type of cell may be established by a flag set for the cell data or a master list of normal and aberrant cells.

Each cell is defined by a location in virtual three dimensional space. Any coordinate system may be employed, but a conventional three dimensional orthogonal (x,y,z) coordinated system is convenient. The coordinate position of each cell may be stored with each cell's data using the preferred data structure. Note that since each cell is uniquely defined by its position (only one cell may occupy any one position in virtual space) the cell coordinate may be used as the cell identifier (i.e., no separate cell identification number or the like need be used, although a cell i.d. for each cell may be used if convenient).

A computational modeling system in accordance with the present invention may preferably simulate a three-dimensional structure of cells residing in a membrane. The membrane defines the maximize size or borders of the virtual three dimensional space in which the cells live and die. The membrane size may be user selectable and may be of any size desired depending on the desired simulation to be run, available computational resources and processing time, etc. The membrane size may be defined in terms of units of locations in space at which a cell may reside. For example, a membrane size of 40×40×20 units would have 32,000 possible cell locations.

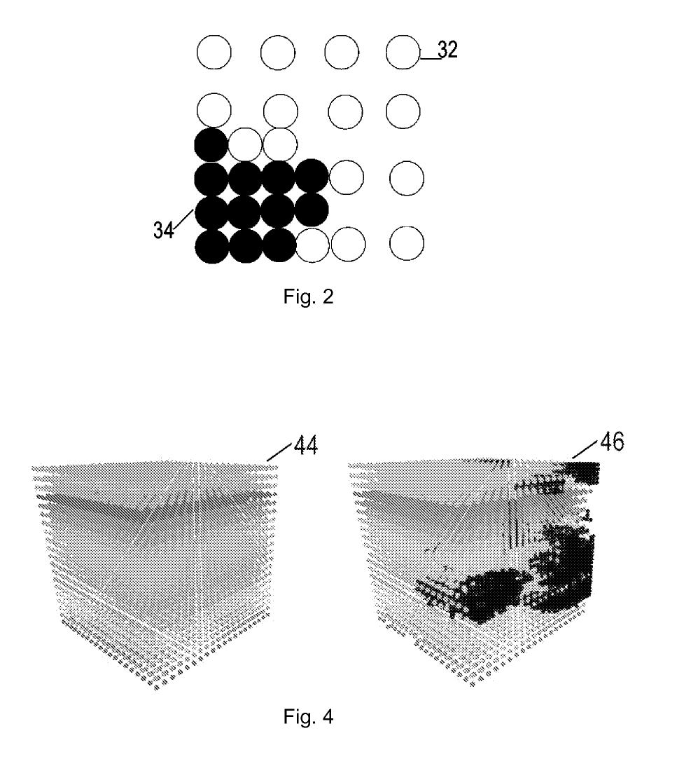

Here we will discuss the first difference between modeled normal cells and aberrant cells. Healthy normal cells do not impede on other cells' space. Thus, in a preferred embodiment of the present invention, healthy cells may not occupy adjacent positions within the membrane space. Thus, in the 40×40×20 membrane space defined above there may be at most 4000 healthy cells, where every other spot within the membrane space represents the natural spacing between neighbors. Aberrant cells are not under such a spacing limitation, and thus may occupy any spot in the membrane space without regard to adjacent normal or aberrant cells. FIG. 2 is a schematic two dimensional representation showing the exemplary relative positional spacing between normal 32 and aberrant 34 cells in a computational model in accordance with the present invention as just described.

Each modeled cell also contains a life protocol in terms of a list of factors that control its functioning and behavior. A mutation causes a factor to cease regulation, unless it is repaired. Six exemplary core factors are:

Replication. Controls whether a cell will replicate. Replication is based on an inherent probability, the cell's age and its generation, as well as the need or availability of the modeled system for more cells.

Replication Suppressant. Checks that the cell does not replicate above threshold probability, which is the mark of a severe problem.

Check Point. Verify that the cell contains no mutations, done before replication.

Repair. If any regulation factor is mutated or otherwise not functioning correctly the cell will try to repair itself.

Apoptosis. Controls the death of a cell. Cells can die due to age, un-repaired damage, or a fixed probability. Self death can be initiated internally, when an internal check shows un-repairable mutation, or may be initiated by signals external to the cell itself. The later will be the basis of the rescue protocols.

Concentration Threshold. Ensures that cells do not over-populate by setting a threshold for concentration or distance among cells. This enables every cell to have its necessary resources available. In some applications, cells may move to distribute concentration as desired. Such cell movement will introduce further complexity of any concurring tumor.

Information among cells is transferred via different mechanisms. One such mechanism is diffusion, in which each cell emits to the environment a fixed value, and the value itself propagates away, becoming smaller with distance. This will be used by the cells to recognize spatial concentrations. Another information transfer mechanism is by direct communication among cells, where cells alert each other about the existence of irregular ones in the area and send messages to initiate apoptosis. This direct communication mechanism is the basis of the rescue protocols.

In the simulation, at each time step each cell performs an action.

Repair. If the cell noticed that it was damaged during the previous time tick, it will attempt to repair itself in the current one.

Death. If the cell has been trying to repair and has failed in previous ticks, it may attempt to kill itself. There is also a random death in the system that can happen at the beginning of a time tick, as well as death due to external signaling.

Replication. A “daughter” cell is formed and sent to a neighboring space that is not over-populated, with a copy of the regulation factors intact. Replication preferably occurs only after the cell is checked for health. At replication, a mutation to any of the life protocols may occur, governed by a probability. The mutation probability is adaptable to environmental conditions.

Movement. In some applications, a cell can move by one space in any direction, as long as that space is not populated.

Participating in rescue protocols. At each step a cell is capable of initiating a rescue signal, of receiving signals, and of propagating signals that have arrived to it.

Aberrant cells have all the regulation factors (replication, replication suppressant, check point, repair, apoptosis, and concentration threshold) ruined. Their replication is not controlled: no check-points, no concentration threshold, and no replication suppressant. They will push the healthy cells away and take over all nutrients. In the simulation, aberrant cells may be introduced by both natural development of collective mutations, and by externally planting them.

Rescue protocols are the way a biological system being simulated avoids being killed by aberrant cells. The underlying assumption is that cells share the citizenship responsibility to care for the whole system and they transfer alert messages for this aim. Alert messages can be initiated in different ways. The following were found most effective:

A message initiated by a cell which senses irregularity in its environment. This may be modeled by a cell noticing elevating levels of over-population. The level of sensitivity (e.g., to concentration) controls the initiation of such messages, and can change with time. For example, knowing of the existence of aberrant cells in the vicinity may raise the cell's sensitivity. We call this message initiated by sensing local irregularity “Please die.”

A cell that was convinced to die by external signaling will announce it in an “I died” message. This message can be sent only once in the life cycle of a cell, since it occurs during its death.

Note that aberrant cells may create any false messages. Their effect is minimized by the manner of setting threshold or trust values at the recipient cells. It will thus require highly coordinated signaling from a team of aberrant cells to convince healthy cells to die from enticed apoptosis.

Signaling is characterized by various parameters including signal strength, the distance it can travel, the duration of the active signaling and the quiet (“refractory”) period between successive signaling by the same cell. Other parameters include sensitivity parameters to initiate signaling and the suicide threshold at the receiving side which includes the accumulative strength of signals required before the cell will execute self death.

The parameters are tuned to maximize their efficiency based on the tumor characteristics. “Please die” is meant to be targeted towards the irregular cells that caused the local changes (e.g., over-population). The default distance and strength are low, so that only cells within a short radius from the sending cell will count it towards the suicide threshold, and the distant cells will receive it in such small values that it will only elevate their future alertness. This signal is likely to be sent by healthy cells due to the presence of irregular ones. If, however, an aberrant cell initiates a false “Please die”, it will kill its neighboring cells faster, and due to the cluster property of the growing tumor, many of its neighbors are aberrant. Furthermore, due to the death threshold in the healthy cells, a coordinated team of “Please die” messages is required to overcome the threshold, which means that an aberrant cell does not easily kill with this technique.

The “I died” signal is especially useful to fight a cluster of aberrant cells from inside. If too weak it will not affect enough and if too strong it will also kill healthy cells outside the cluster. The default distance of this signal is slightly higher than for the “Please Die.” This signal causes the dying cells to again be part of the citizenship of the system (even if they are not doing it intentionally). For this signal to be effective it is important that aberrant cells can send and receive signals as well.

Cells that receive enough alert signals will consider themselves to be problematic and will activate their own apoptosis. These are considered the suicide thresholds. Suicide thresholds are chosen so as to increase the probability that aberrant cells die and decrease the probability that healthy cells die due to signaling. The efficient rules were found to be:

Consider only signals that arrive within a window of time, where the window corresponds with the duration of a signal between quiet periods, and let the effect of previous signals fade. This technique will prevent a single cell from causing the death of another one.

Consider combinations of thresholds for the two signals as well as a common accumulative (non-differentiating) threshold.

If cells have identity, count a signaling cell once towards the suicide threshold.

It is possible that the aberrant cells were not diagnosed on time and the rescue protocols cannot handle the amount of the harm already done or the level of aggressiveness of the aberrant cells. In this case the system will call for external help, e.g., surgery, radiotherapy, and/or chemotherapy. These outside treatments will attack the aberrant cells in a more violent way. Unfortunately, they will also harm the healthy cells to some extent since they are not specific enough. Best results for these techniques are achieved when combined with the rescue protocols.

Exemplary methods for the set-up and initiation of a cellular tumor simulation using a computational modeling system and method in accordance with the present invention will now be described. Set-up and initiation may be performed by an operator or user on the computer system 20 preferably using graphical user interfaces provided by the system. Preferably intuitive windows-type graphical user interfaces may be provided. It should be understood that various other graphical user interfaces, differing in form and content from those to be described by example herein, may be used in accordance with the present invention.

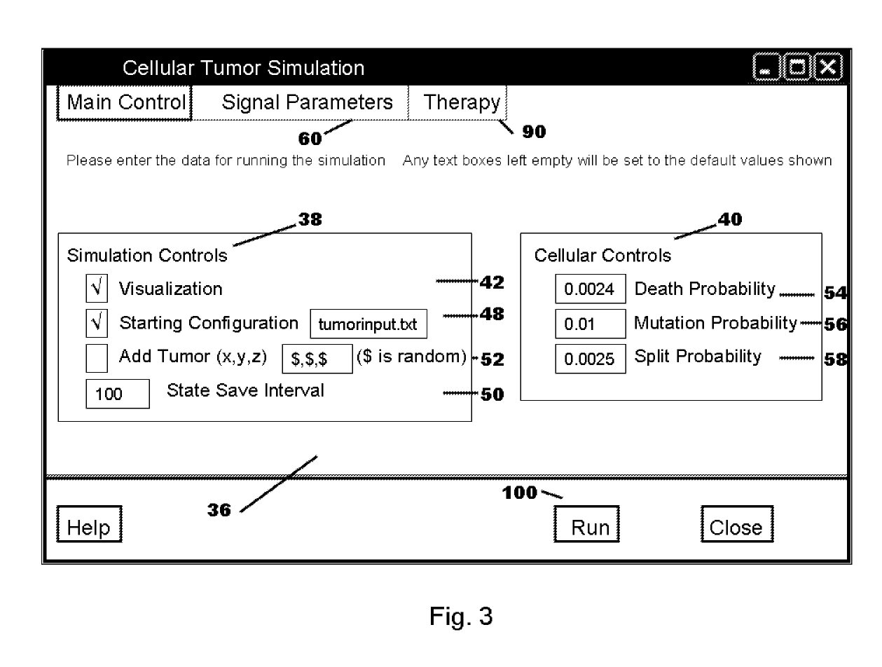

An exemplary main control graphical user interface 36 is illustrated in FIG. 3. The main control 36 provides for overall simulation controls 38 and cellular controls 40. The simulation controls 38 allow the operator to select graphical visualization output 42 of the simulation. Such exemplary graphical visualization outputs (44, 46) are illustrated in FIG. 4. As illustrated, the visualizations are three-dimensional representations of the cell structure being simulated with dots representing cells at the various cell locations in the virtual space. The dots may be of different colors to represent healthy (e.g., red, green) cells versus aberrant (e.g., black) cells and to enhance the visualization. In this case, the top visualization 44 is a healthy system. The bottom visualization 46 is the system in the middle of fighting aberrant cells, where the black cells are being killed and the healthy ones are going to start growing to take over the newly empty areas.

Continuing with the simulation controls 38, the user may select a starting cell configuration 48 by specifying a file defining such a configuration. This may be a manually created configuration or one saved from a previous simulation run. In the absence of selecting such a starting configuration 48 a default starting configuration may be used. For example, the default starting configuration may be a single healthy cell located at the center of the membrane space.

The operator may also specify 50 how often, i.e., after how many simulation cycles, the state of the simulation is saved. A default value of every 100, for example, cycles of the simulation may be provided for this parameter. Note that a new simulation may be restarted from any saved simulation.

The operator may manually add 52 a tumor into the cellular simulation by specifying a coordinate location for an aberrant cell. Alternatively, the operator may allow the system to randomly position a tumor cell in the membrane space. Note that if a tumor is not manually added 52 in this manner, either at a specified or random position, it is still possible for tumors to develop given that each cycle of the simulation there is a small probability chance that each normal cell will mutate into an aberrant cell.

Turning now to the various cellular controls 40. The operator may specify a death probability 54 for the cells. The death probability 54 is applied each cycle to each normal and aberrant cell and is the probability that each cell will die in any given cycle. A default death probability 54 of 0.0024 may, for example, be used.

The operator may specify a mutation probability 56. The mutation probability 56 is applied each cycle to each normal cell and is the probability that a normal cell will mutate into an aberrant cell in any given cycle.

The operator may specify a proliferation probability 58. The proliferation probability 58 is applied each cycle to each normal and aberrant cell and is the probability that each cell will generate another cell having the same characteristics in any given cycle. The difference between normal and aberrant cells in this respect is that normal cell splitting is subject to other constraints, as discussed above, such as normal cell spacing, aberrant cell division is not subject to such restraints. In the presence of dieing cells and the “I died” signal healthy cell proliferation can be elevated.

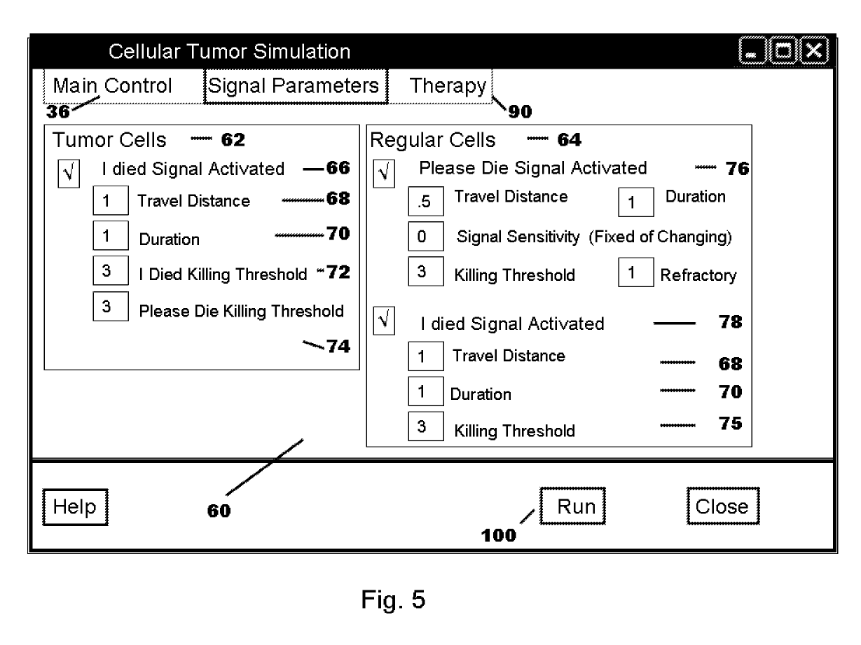

An exemplary graphical user interface 60 for specifying signal parameters is illustrated in FIG. 5. An operator preferably may specify signal parameters for tumor or aberrant cells 62 and/or regular or normal cells 64.

The “I Died” signal may be activated for all cells (tumor cells 66 or normal cells 78) for when such cells die by enticed apoptosis. The characteristics of the “I died” signal that may be specified include how far the signal will travel 68, e.g., specified in units of coordinate distance, and for how long after the cell dies will the signal be present 70, e.g., specified in simulation time steps. The operator may also specify the “I Died” 72 and “Please Die” 74 killing thresholds for tumor cells and the “I Died” killing threshold 75 for normal cells. These are the cumulative strengths of “I Died” and/or “Please Die” signals that must be received by each tumor or normal cell before causing it to die. The selected signal parameters apply to all tumor cells or normal cells, as appropriate, in the simulation.

For regular cells 64, the operator may also select activation of the “Please Die” signal 76 and specify parameters thereof. These selected signal parameters apply to all regular cells in the simulation.

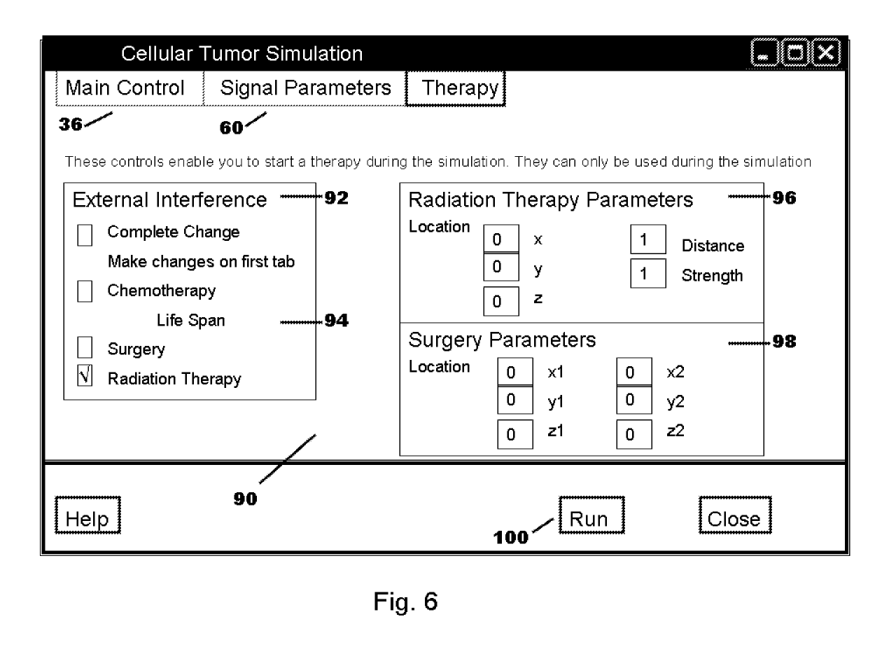

An exemplary graphical user interface 90 for introducing external therapies into a biological system being simulated in accordance with the present invention is illustrated in FIG. 6. External therapies 92 that may be selected include chemotherapy, surgery, and radiation therapy. (Additionally or alternatively, a change in therapy may be simulated by changing other parameters in the simulation such as the death, mutation, and proliferation probabilities as selectable using the main controls 36 graphical user interface (FIG. 3)).

For chemotherapy a life span 94 of the chemotherapy may be selected. Chemotherapy affects all cells in the model.

For radiation therapy 96 a location of the center of the radiation in the three dimensional model space is specified along with a distance from this center point and a strength. The radiation therapy only affects cells within the specified distance from the defined center of therapy.

For surgery 98 a location of the surgery in the modeled space is specified. All cells in the defined region of the modeled space are removed.

After all of the desired simulation parameters have been selected and defined, the simulation may be run by selecting the “Run” button at the bottom of any of the graphical user interfaces described.

Exemplary use of a computational modeling system and method in accordance with the present invention to model malignant transformation in tissue under various conditions, and the results achieved thereby, will now be presented. The computational modeling system was initialized by one cell that was wrapped by a membrane. The membrane restricts the size of the biological system being modeled. In this case, the membrane enabled cells to fill up a volume that can hold 4000 healthy cells that respect healthy cell separation distance or 32,000 aberrant cells which touch each other. The output of the computational modeling system included 3D visualization where the colors green to red show healthy cells in different depths and aberrant cells are black.

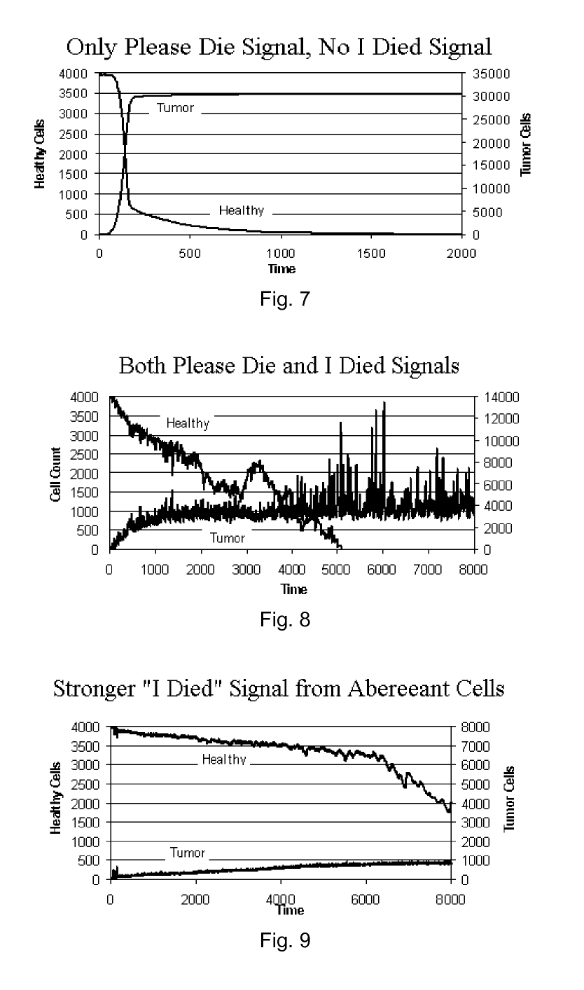

In a first test of the simulation only the “Please die” signal was enabled. This signal was found to be unsatisfactory on its own. As shown in FIG. 7, if only the “Please Die” signal is used and not the “I died” signal, there is an exponential growth of tumor cells until they reach a total of 30,000. The number of healthy cells decreased to less than 1,000 after only 161 steps, and they decrease to a single cell within 2363 steps.

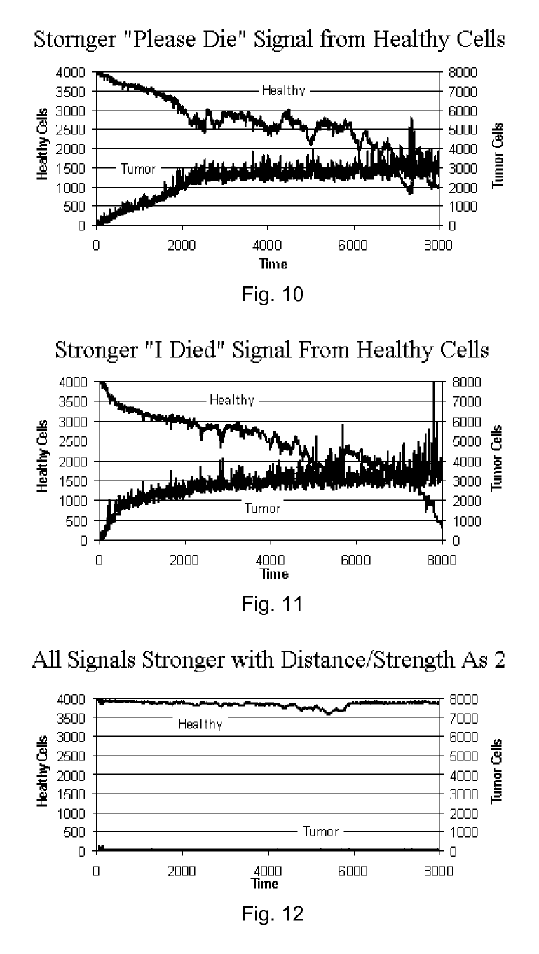

The simulation was repeated after including the “I died” signal as well. (Testing with only the “I died” signal is not an option since there is no initial external-initiated dying without the “Please die” signal.) For each signal we changed the initiating signal strength as well as the distance it can travel. FIGS. 8-12 demonstrate how increasing the strength and distance of the different signals from 1 to 2 improves the effectiveness of the protocol in both eliminating tumor cells as well as in maintaining healthy cells. FIG. 8 depicts a basic situation where the strength/distance of the “I died” signal was 1/1 and the strength/distance for the “Please die” was 1/0.5. In FIG. 9 we increased the strength and distance of the “I died” signal initiated at tumor cells. In FIG. 10 we increased the strength and distance of the “Please die” signal. In FIG. 11 we increased the strength and distance of the regular cell's “I died” signal. FIG. 12 depicts the most robust scenario where the strengths and distances of all “I died” and “Please die” signals were increased to 2 and 2 respectively. The replication rate in all these runs were 0.1, and death threshold was 2.

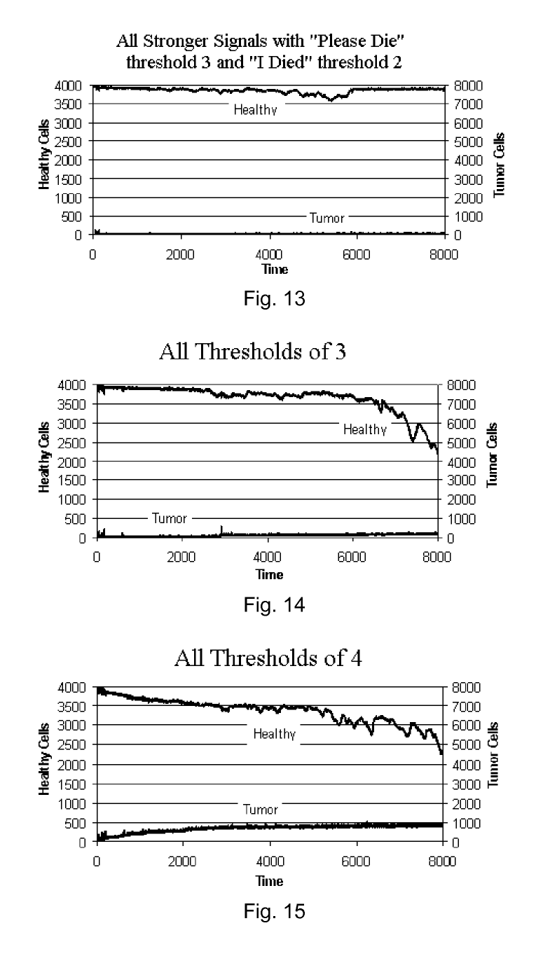

Various threshold values to entice apoptosis were tried. In FIG. 12 a cell starts enticed apoptosis when either the accumulated strength of the received “Please Die” signals is 2 or the accumulated strength of the received “I Died” signals is 2. This situation is compared with FIG. 13 where the “Please Die” threshold is 3, FIG. 14 where both thresholds are 3, and FIG. 15 where both thresholds are 4. The best result is reached with a threshold of 2 (FIG. 12) with 3889 healthy cells and 66 tumor ones at the end of the simulation.

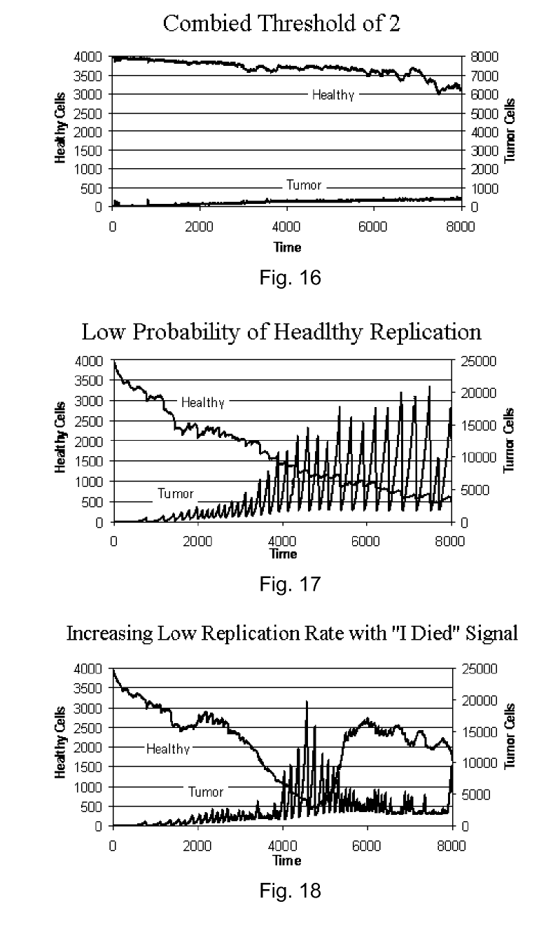

In a further set of experiments the modeled cells did not differentiate between the messages from the two types of protocols, thus applying “combined thresholds.” As shown in FIG. 16, when the two signals were undifferentiated by the receiving cell with a threshold of 2, the final result was just a little less robust than when signals where accumulated separately.

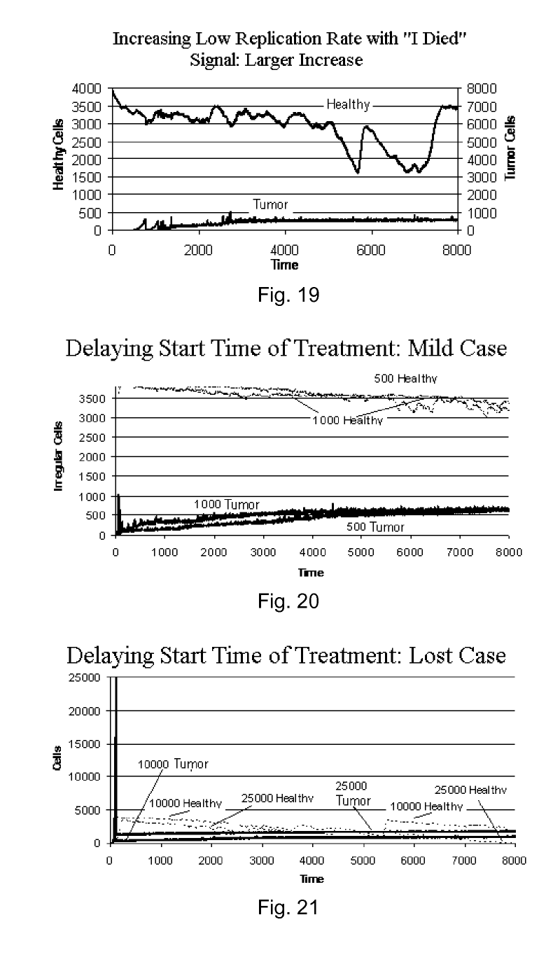

All above runs used an inherent replication rate of 0.1 for healthy cells, which was utilized when environmental conditions enabled replications. This rate does not affect tumors cells as they replicate aggressively. In FIG. 17, the parameters of FIG. 9 were repeated except that the healthy replication rate was down to 0.01. We then experimented with a new effect of the “I died” signal on healthy cells: whenever a healthy cell receives an “I died” signal it increases its probability of replication. (Note that this will be affective as long as the threshold for enticing apoptosis has not been reached in which case the cells die. So the “I died” entices increased replication rates in healthy cells only when received in small quantities.) In FIG. 18 the replication probability increased by 0.01 with each signal received, while in FIG. 19 the replication rate increased by 0.03. We observe that systems with more conservative (lower) replication probabilities can be as successful in fighting tumors as highly replicating systems, if the cells have the ability of increasing their replication probability when observing increases of environmental enticed deaths. This property is thus suggested as highly beneficial for increasing the modeled system's robustness.

Delayed start of the rescue protocols treatment was simulated, and was found to strongly compromise the health of the modeled system. When treatment starts too late the system may be unable to overcome the harm that was done initially, even with more aggressive parameters of the protocols. In FIG. 20, the “Please Die” signal was stalled until either 500 or 1000 aberrant cells existed in the system. These delays were small enough and did not cause much harm. However, in FIG. 21 the “Please Die” signal was stalled until counts of 10,000 or 25,000 and the effect on the system became significant. The effect is most pronounced for the delay of 25,000, as a tumor is taking over the whole system.

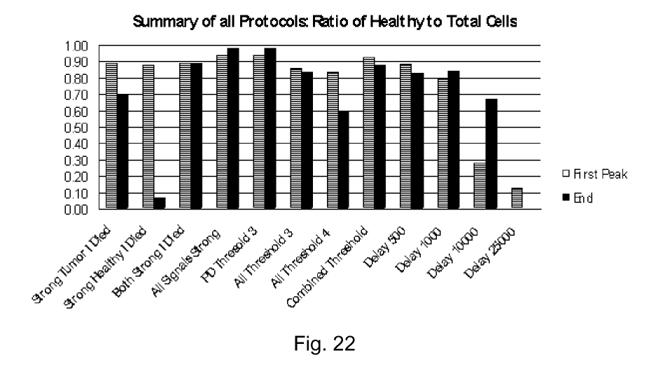

FIG. 22 depicts the ratio of healthy cells to total cells that occur for the various parameter settings of the rescue protocols discussed above. Each scenario is measured at two points in time: to the left is the ratio at the first peak of tumor cells (typically the worse situation), and to the right the ending equilibrium when the protocol was enabled. A ratio of 1 is ideal, meaning that the system contains 100% healthy cells. From all parameter settings tried above the most robust protocol is when all signals are strong (distance/strength is 2/2) with a threshold of 2 for the “I died signal” and either 2 or 3 for the “Please die” threshold; the final ratio of healthy to total cells is 0.98 for both cases. The next best setting was with only strong “I Died” signals (for both tumor and healthy cells) and with thresholds of 2 for signals, this had a final ratio of 0.89. The case where all signals had distance/strength of 212 and were combined for the calculation of enticing threshold was close with a ratio of 0.88. After that was a tie between the cases of a delay of 1000 and when all thresholds were 3, with the final ratio of 0.84. A ratio of 0.83 occurred with a delay of 500, a ratio of 0.67 for the delay of 10,000, and the delay of 25,000 brought about the fatal ratio of 0.

The above results demonstrate the proof of concept that a computational modeling system and method in accordance with the present invention can be used to demonstrate that rescue algorithms are able to confine aberrant cells and isolate them. Systems parameters are identifiable by a system and method in accordance with the present invention in a case-by-case basis based on cell characteristics.

Having described certain embodiments, numerous alternative embodiments or variations can be made. As shown and described, the system and method disclosed herein is directed to the treatment of cancer. However, this is merely an example. Alternatively, the teachings disclosed herein may be directed to any number of diseases or anomalous conditions, such as infected cells or cells that have become defective due to metabolic changes, such as atherosclerosis, for example. Therefore, the invention is not limited to applications involving cancer but may be extended to a host of other conditions involving normal and aberrant cells.

As shown and described, various adjustable parameters are provided for simulated cells. Some parameters apply to all cells, others apply to all normal cells, and still others apply to all aberrant cells. Alternatively, however, each individual cell may be provided with its own set of adjustable parameters. For example, rather than having a single killing threshold applicable to all tumor cells, as shown in FIG. 5, each individual tumor cell may be provided with its own killing threshold setting, which may be different from, or the same as, the killing threshold settings of other tumor cells.

It should be noted, therefore, that the present invention is not limited to the particular exemplary applications and embodiments illustrated and described herein.

What is claimed is:

1. A system for simulating behavior of biological tissue, comprising:
a simulated space; and
a plurality of cells within the simulated space representing biological cells of a living tissue;
wherein each of the plurality of cells is constructed and arranged for communicating signals with its neighboring cells within the simulated space, said signals including a signal for indicating that a respective cell is experiencing apoptosis.

2. A system as recited in claim 1, wherein the plurality of cells within the simulated space comprise both simulated normal cells and simulated aberrant cells.

3. A system as recited in claim 2, wherein said signal for indicating that the respective cell is experiencing apoptosis is a first signal, said signals further including a second signal, for enticing cells in a vicinity of a cell initiating said second signal to undergo apoptosis.

4. A system as recited in claim 2, wherein both simulated normal cells and simulated aberrant cells are constructed and arranged for initiating the signal for indicating that a respective cell is experiencing apoptosis.

5. A system as recited in claim 2,
wherein the simulated space comprises a 3-dimensional grid, and wherein each cell has a location on the 3-dimensional grid,
wherein normal cells not directly adjacent to aberrant cells on the 3-dimensional grid have no cells that are directly adjacent to them, and
wherein aberrant cells have other cells on the 3-dimensional grid that are directly adjacent to them.

6. A system as recited in claim 1, wherein said neighboring cells are constructed and arranged for elevating proliferation of healthy cells in response to said signal for indicating that the respective cell is experiencing apoptosis.

7. A system as recited in claim 1, wherein neighboring cells that receive said signal for indicating that a respective cell is experiencing apoptosis are themselves constructed and arranged to undergo apoptosis responsive to an accumulated level of said signal.

8. A system as recited in claim 7, wherein at least some of the neighboring cells are unable to initiate their own apoptosis but are constructed and arranged to undergo apoptosis responsive to said accumulated level being exceeded.

9. A system for simulating behavior of biological tissue, comprising:
a simulated space; and
a plurality of cells within the simulated space representing biological cells of a living tissue;
wherein at least some of the plurality of cells is constructed and arranged for initiating a signal responsive to a local irregularity in a vicinity of each respective cell within the simulated space.

10. A system as recited in claim 9, wherein the irregularity is an overpopulation of cells.

11. A system as recited in claim 10, wherein said cells that receive said signal are constructed and arranged for elevating a sensitivity of healthy cells to said signal in response to repeated receipt of said signal.

12. A system as recited in claim 9, wherein cells that receive said signal are themselves constructed and arranged to undergo apoptosis responsive to an accumulated level of said signal.

13. A system as recited in claim 12, wherein at least some of the cells that receive said signal are aberrant cells that have no ability to initiate their own apoptosis internally.

14. A method of modeling the behavior of biological tissue, comprising:
providing a modeled space;
providing a plurality of modeled cells within the modeled space; and
detecting, by one or more of the plurality of modeled cells, an irregularity in a vicinity of the modeled cell within the modeled space.

15. A method as recited in claim 14, further comprising:
initiating, by at least one of the plurality of modeled cells, at least one signal of a first type for indicating that the at least one modeled cell is experiencing apoptosis; and
communicating, responsive to the step of detecting by said one or more of the plurality of modeled cells, at least one signal of a second type, to a neighboring region within the modeled space.

16. A method as recited in claim 15, further comprising enticing apoptosis of cells, responsive to the step of communicating, in the neighboring region within the modeled space.

17. A method as recited in claim 15, wherein the step of providing the plurality of modeled cells comprises providing both normal cells and aberrant cells.

18. A method as recited in claim 17, wherein the step of initiating the signals of the first type is conducted for both normal and aberrant cells.

19. A method a recited in claim 18, further comprising enticing apoptosis of cells in a vicinity of a cell initiating the signal of the first type.

20. A method a recited in claim 18, further comprising enticing apoptosis of cells in a vicinity of a cell communicating the signal of the second type.

21. A method as recited in claim 18, further comprising increasing a sensitivity of normal cells to communicate signals of the second type responsive to the step of communicating the at least one signal of the second type.

22. A method as recited in claim 18, further comprising increasing proliferation of healthy cells responsive to the step of initiating the at least one signal of the first type.

23. A method as recited in claim 14, wherein the irregularity in the environment is a local overpopulation of cells.

24. A method as recited in claim 14, wherein at least some of the plurality of modeled cells are constructed and arranged for passing along signals initiated by others of the plurality of modeled cells based on settings of said others of the plurality of modeled cells.

25. A method as recited in claim 14, wherein each of the plurality of modeled cells has at least one setting for individually controlling the respective cell's behavior in response to signals initiated by other modeled cells.

26. A method as recited in claim 14, further comprising initiating a signal, by the respective one of the plurality of cells, for enticing other cells in the vicinity of the respective cell to undergo apoptosis.

27. A method operable by a user for simulating the development and treatment of disease or abnormality in a biological system, comprising:
providing a plurality of cells within a simulated space, wherein some of the plurality of cells are healthy and some are aberrant or have an ability to mutate to become aberrant;
providing a user interface from which a user may specify settings for the plurality of cells for suppressing the aberrant cells;
executing a simulation of the tissue in sequential steps; and
alerting the user, responsive to the executing step, if the aberrant cells cannot be suppressed.

28. A method as recited in claim 27, further comprising simulating at least one of surgery, radiotherapy, and chemotherapy, for attacking the aberrant cells.

29. A method as recited in claim 27, further comprising saving the simulation at a location during its execution.

30. A method as recited in claim 29, further comprising:
resuming the simulation from the saved location with a first simulated treatment;
resuming the simulation from the saved location with a second simulated treatment; and
comparing simulation results for the first and second treatments,
wherein the first and second simulated treatments include any of rescue algorithms, surgery, radiotherapy, chemotherapy, hormone therapy, and biological therapy, or any combination thereof.

31. A method as recited in claim 29, further comprising:
resuming the simulation from the saved location with a first set of settings for the plurality of cells for suppressing the aberrant cells;
resuming the simulation from the saved location with a second set of settings for the plurality of cells for suppressing the aberrant cells; and
comparing simulation results for the first and second sets of settings.
